(19) United States
(12) Patent Application Publication
(10) Pub. No.: US 2025/0242985 A1
(43) Pub. Date: Jul. 31, 2025

(54) CONTAINER TAMPER DETECTION CAPSULE, CONTAINER LID AND CAPSULE AND LID PRODUCTION PROCESSES

(71) Applicant: AMORIM TOP SERIES, SA, ARGONCILHE (PT)

(72) Inventors: DANIEL GOMES DE OLIVEIRA, SANTA MARIA DA FEIRA (PT); SUSANA MADALENA CARDOSO GUEDES, MAIA (PT); SARAH LAGORSSE DE RIBEIRO PONTES, PORTO (PT)

(21) Appl. No.: 19/041,064

(22) Filed: Jan. 30, 2025

(30) Foreign Application Priority Data
Jan. 31, 2024 (PT) 119234

(51) Int. Cl. B65D 55/02; B65D 39/00; B67B 1/04

(52) U.S. Cl. CPC B65D 55/026; B65D 39/0076; B65D 39/0088; B65D 39/0094; B67B 1/04

(57) ABSTRACT

The present invention relates to a container tamper detection capsule (1) comprising an upper cover member (2), a lower cover member (4) and an axial displacement member (3), wherein the latter comprises an alignment member (5) and an insertion member (6). Said axial displacement member (3) is axially displaceable from a first closed position, to a second open, fixed and irreversible position. The invention also relates to a container lid (8) comprising the capsule (1) and a stopper member (7). Lastly, the invention also relates to production processes for the capsule (1) and lid (8), which are intended to close containers of food or non-food products.

### FIELD OF THE INVENTION

The present invention relates to a container tamper detection capsule, designed to provide information to a user of the existence of an attempt to tamper with the container closed with such a capsule. The invention also relates to a container lid, comprising said capsule and a stopper member, designed to seal any container. Lastly, the invention also relates to capsule and lid production processes. The present invention finds application in the field of production and marketing of capsules for all types of containers, in particular, containers of food or non-food products.

### BACKGROUND OF THE INVENTION

It is well known to use capsules with mechanisms that allow easy identification of the first time a container closed with such a capsule is opened, in particular, in bottles of beverages or food products. Many of these capsules that are currently on the market constitute systems that can be damaged, in other words, when first opening a container closed with such a capsule, it is necessary to partially damage that capsule, or else the same is completely damaged the first time it is removed from the container.

Another problem found in these capsules is the reversibility of the mechanisms that allow them to operate. In other words, if the function of these capsules is to inform consumers about the first opening of a container closed with such a capsule, it is imperative that this capsule does not present faults with regard to the irreversibility of its operating mechanism, otherwise the reversibility of its operating mechanism can be used by a hypothetical counterfeiter to circumvent the security and authenticity of the capsule.

For example, WO 2014/122300 discloses a capsule with a mechanism that allows a user to identify whether a container closed with such a capsule has been tampered with. The capsule disclosed in this document is composed of a top lid, a spring, an internal member and an external cylindrical member, movable relative to the internal member, from a first position corresponding to the closed position, before the first opening of the container, to a second position, after a user removes the capsule. The operating mechanism acts so that when the capsule is first removed from the container, in other words, when the capsule is triggered for the first time, the spring, fixedly housed in the internal member, cooperates with the external cylindrical member and allows the blocking of this external cylindrical member relative to the internal member, in said second position, showing a change in the shape of the capsule that allows a user to identify the container's tampering.

However, the design of the capsule disclosed in the prior art document aforementioned allows a user to tamper with a container closed with such a capsule without triggering the detection mechanism, in other words, it makes it possible to remove the capsule (and its stopper) from the container without triggering the mechanism.

In some embodiments of said capsule, it is also possible to unlock its detection mechanism after its activation and restore it to the original safe position. This weakness makes it possible to remove the capsule (and its stopper) from the bottle and then, after restoring its original detection configuration, reinsert it into the same container or another, without leaving any evidence of its tampering.

It is also possible to open a closed bottle with the capsule disclosed in the abovementioned document, without the operating mechanism of that capsule being activated, due to the combination of movements between the outer cylindrical component and the inner component. Given that in the capsule of document WO 2014/122300, the base of the outer cylindrical member and the base of the inner member share the same plane, in other words, they are both in the same position before the triggering of the capsule, it is thus possible to access the base or lower end of the inner member without moving the outer cylindrical member that triggers the capsule detection mechanism. Since it is the movement of the outer cylindrical member with respect to the inner member that triggers the mechanism, it is understood that by preventing such movement during the removal of the capsule, its removal can be achieved without triggering the mechanism. For example, by placing an object between the top of the neck of the container and the base of the capsule, it is possible to pull the capsule, resting said object on the base of the inner member without causing any movement of the outer cylindrical member.

In turn, document PT 108721 relates to a container tamper detection capsule that allows the user to identify whether said capsule was pulled or if there was an attempt to pull it with the aim of removing it from the mouth or neck of a container. The capsule disclosed in this document is composed of an upper cover member (2), an inner spring support member (3), a spring member (4) and a lower cover member (5). Said upper cover member (2) is coupled to the lower cover member (5), forming an assembly (25) that defines a cavity within. This assembly (25) is displaceable from a first closed position to a second open position, and is configured to move said spring member (4) between said first and second positions. In turn, the inner spring support member (3) is disposed in the cavity of the assembly (25) and the spring member (4) is disposed in the cavity of the assembly (25) and is movable between: said first closed position, in which it is arranged in a tensioned state on the inner spring support member (3), and said second open position, in which it is arranged in a state of rest between the inner spring support member (3) and the upper cover member (2), blocking the assembly (25) in the second open position. This blocking of the assembly (25) in the second open position prevents it from returning to the first closed position, this blocking mechanism being irreversible. After triggering the capsule (1), to remove it from the container where it is arranged, said spring moves to a second position in which it is freed from the tension to which it was subjected before triggering, which results in its dimensional change. This dimensional change will allow the capsule (1) to be irreversibly blocked in a tamper-indicating position, which allows a user to identify tampering with the container.

However, the capsule design disclosed in the prior art document aforementioned has a pronounced visual impact on the aesthetics of the final product due to the way it demonstrates the attempt to tamper with the capsule, not being suitable for luxury/high added value products.

Thus, according to the above, there is a need in the art for a container tamper detection capsule with an irreversible blocking mechanism and that allows to demonstrate to the user the tampering, without having a marked visual impact on the aesthetics of the final product, in other words, that the demonstration of the tampering of the capsule causes a visual change detectable to the user, but that this is subtle and framed in the design of the final product.

### SUMMARY OF THE INVENTION

The present invention relates to a container tamper detection capsule (1) comprising:
an upper cover member (2) comprising a top through-opening (21),
an axial displacement member (3) comprising an alignment member (5) and an insertion member (6), and
a lower cover member (4) comprising a bottom through-opening (41),
wherein
the upper cover member (2) is coupled to the lower cover member (4), forming an assembly (24) that defines a cavity within; and
the axial displacement member (3) is arranged in the cavity of the assembly (24), said insertion member (6) being fitted to the lower cover member (4) and said alignment member (5) inserted into the top through-opening (21) of the upper cover member (2);
wherein, in operation, the axial displacement member (3) is axially displaceable relative to the assembly (24) from a first closed position, in which a face (51) of the alignment member (5) is aligned with a top surface (22) of the upper cover member (2), to a second open, fixed and irreversible position, in which the insertion member (6) is axially blocked in the lower cover member (4) and said face (51) of the alignment member (5) is recessed with respect to said top surface (22) of the upper cover member (2).

In one aspect of the invention, the insertion member (6) and the lower cover member (4) comprise clip-type and indentation-type axial retention means.

In yet another aspect of the invention, the upper cover (2) and lower cover (4) members are made of a material selected from the group consisting of plastic, wood, cork, composites and combinations thereof.

The present invention also relates to a container lid (8) comprising the capsule (1) and a stopper member (7), designed to seal any type of container.

In one aspect of the invention, the stopper member (7) is made of a material selected from the group consisting of plastic, wood, cork, aluminium, composites and combinations thereof.

The present invention also relates to a capsule production process (1) comprising the following steps:
fitting the insertion member (6) of the axial displacement member (3) to the lower cover member (4); and
attaching the upper cover member (2) and the lower cover member (4), by inserting the alignment member (5) into the top through-opening (21) of the upper cover member (2).

Additionally, the present invention relates to a production process of the container lid (8) comprising the following steps:
fitting the insertion member (6) of the axial displacement member (3) to the lower cover member (4);
attaching the upper cover member (2) and the lower cover member (4), by inserting the alignment member (5) into the top through-opening (21) of the upper cover member (2); and
gluing a top of the stopper member (7) to a face (61) of the insertion member (6) through said bottom through-opening (41) of the lower cover member (4).

Lastly, the present invention relates to the use of the capsule (1) and the lid (8) to close containers containing food or non-food products, in particular, containers containing a beverage selected from the group consisting of wine, beer, spirits, water and soft drinks or containers containing a cosmetic product.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the schematic exploded view of the components of the container tamper detection capsule (1), according to the present invention: upper cover member (2), lower cover member (4), alignment member (5) and insertion member (6), these last two constitute the axial displacement member (3). Also shown is the stopper member (7), which together with the capsule (1) constitutes the container lid (8);

FIG. 2 depicts the schematic exploded view of the components of the container tamper detection capsule (1), according to the present invention: upper cover member (2), axial displacement member (3) and lower cover member (4), including the stopper member (7);

FIG. 3 illustrates the capsule (1) of the present invention associated with a stopper member (7), in its two possible operating positions: (A) in the first closed position, on the left side of the figure, and (B) in the second open position, after tampering, on the right side of the figure;

FIG. 4 depicts the cross-sectional view of the container tamper detection capsule (1), including the stopper member (7), in the first closed position (A) and in the second open position (B);

FIG. 5 illustrates the lower cover member (4) comprising a bottom through-opening (41);

FIG. 6 illustrates the lower cover member (4) comprising a bottom through-opening (41);

FIG. 7 shows the alignment member.

FIG. 8 shows the insertion member.

FIG. 9 shows the axial retention means between the lower cover member (4) and the insertion member (6), wherein: (A) represent the axial position blocking means and (B) represent the axial rotation blocking means; and

FIG. 10 depicts the insertion member (6) fitted to the lower cover member (4) through the axial retaining means in the first closed position.

### DETAILED DESCRIPTION OF THE INVENTION

The present invention relates to a container tamper detection capsule and to its production process. Said capsule is intended, in particular, to close containers containing food or non-food products. This invention allows a user to immediately notice whether the capsule has been tampered with and, therefore, whether there has been at least one attempt to open the container. The invention further relates to a container lid comprising said capsule and a stopper member and to the production process of said lid.

In the context of the present invention, the term “container” relates to an object with a generally globular body closed shape, with a mouth or neck, intended to receive a food or non-food product. The capsule of the present invention is intended, for example, for food product containers, namely for beverage containers, for example, bottles for beverages selected from the group consisting of wine, beer, spirits, water, soft drinks and the like. Naturally, the capsule of the invention can also be used in containers for non-food products, since the nature of the capsule is not limited by the type of container that it can close or cover, nor by the product contained in that container.

The expression “container mouth” relates to the open part of a container, for example, a bottle neck.

The term “capsule” relates to a cover for closing or covering a container, being arranged on the outside thereof, for example, covering the free end of the neck of a bottle, and the capsule may be associated with a stopper that is arranged inside the mouth of the container. A capsule can be made from any suitable material, although it is normal to use plastic materials.

In turn, the expression “stopper member” relates to a body with a substantially cylindrical or conical shape with two ends. One of the ends may be chamfered or bullnose and is intended to be inserted partially or fully into the mouth or neck of a container, and the opposite end may be connected by any means to a capsule, if so desired.

The expression “cork material” or simply “cork” relates to natural cork, colmated natural cork, agglomerated cork, microagglomerated cork or combinations thereof.

The expression “plastic material” or simply “plastic” relates to polyethylene terephthalate (PET), polyethylene, high-density polyethylene (HDPE), polyvinyl chloride (PVC), polypropylene (PP), polystyrene (PS), acrylonitrile butadiene styrene (ABS) or the like or combinations thereof.

In the context of this description, the term “comprising” should be understood as “including, among others”. As such, said term should not be interpreted as “consisting only of”.

The triggering of the capsule of the present invention occurs whenever a user pulls or attempts to pull said capsule with the aim of removing it from the mouth or neck of a container.

When the capsule is tampered with and, as such, its detection mechanism is triggered, a visual change occurs at the top of the capsule, with a misalignment of two constituent members of the capsule being visible in its upper part.

The container tamper detection capsule (1) of the present invention comprises the following members:
an upper cover member (2) comprising a top through-opening (21),
an axial displacement member (3) comprising an alignment member (5) and an insertion member (6), and
a lower cover member (4) comprising a bottom through-opening (41).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Said upper cover member (2) is coupled to the lower cover member (4), forming an assembly (24) and that defines a cavity within.

In turn, said axial displacement member (3) is arranged in the cavity of the assembly (24), said insertion member (6) being fitted to the lower cover member (4) and said alignment member (5) inserted into the top through-opening (21) of the upper cover member (2).

The capsule (1) of the invention, when in operation, its axial displacement member (3) is axially displaceable relative to the assembly (24) from a first closed position, in which a face (51) of the alignment member (5) is aligned with a top surface (22) of the upper cover member (2), to a second open, fixed and irreversible position, in which the insertion member (6) is axially blocked in the lower cover member (4) and said face (51) of the alignment member (5) is recessed with respect to said top surface (22) of the upper cover member (2).

Thus, contrary to the capsule mechanism of the prior art, the capsule (1) of the present invention comprises an axially displaceable member, the axial displacement member (3), which moves axially within the cavity of the assembly (24). Before the triggering of the capsule (1), the face (51) of the alignment member (5) is aligned with a top surface (22) of the upper cover member (2). After triggering the capsule (1), to remove it from the container where it is arranged, occurs a displacement of said face (51) of the alignment member (5), being recessed with respect to said top surface (22) of the upper cover member (2), thus occurring a misalignment of said face (51) relative to the surface (22). When this misalignment occurs, the insertion member (6) is axially blocked in the lower cover member (4), and consequently said misalignment is irreversibly blocked, allowing the capsule (1) to remain in a tamper-indicating position, in other words, there is a misalignment between the face (51) and the surface (22), visible to the user.

The capsule of the present invention fully solves the problem identified in the capsules of the prior art, preventing any removal or attempt to remove the capsule from being possible without its triggering, providing an irreversible and tamper-proof blocking of its operating mechanism due to its new design and providing irreversible detection in a simple manner by mechanical means and without causing damage or aesthetic alteration to the capsule.

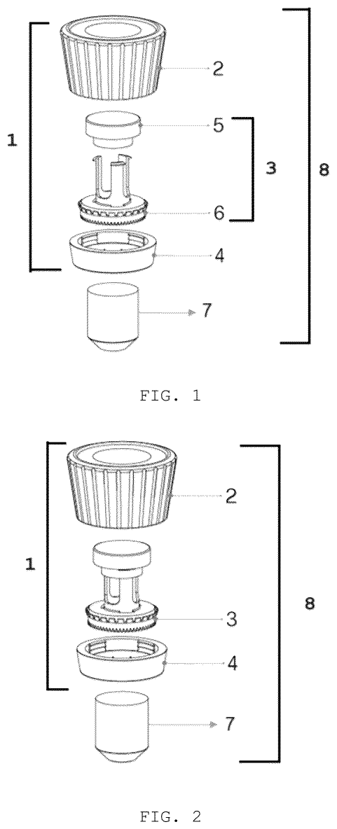

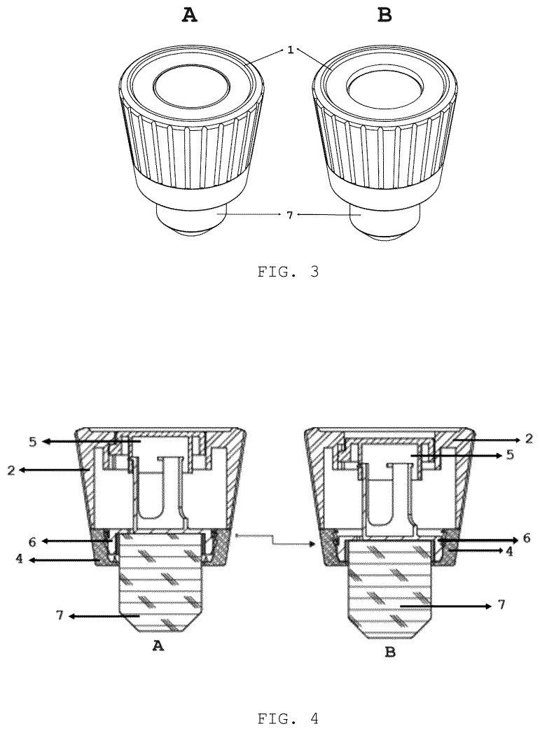

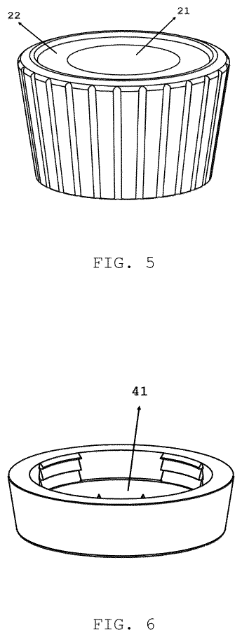

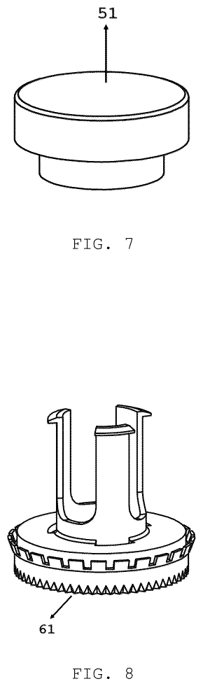

Referring to FIGS. 1 to 10, the capsule (1) of the present invention comprises an upper cover member (2), an axial displacement member (3) and a lower cover member (4), wherein:
the upper cover member (2) is coupled to the lower cover member (4), forming an assembly (24) that defines a cavity within;
the axial displacement member (3) comprises an alignment member (5) connected to an insertion member (6);
the axial displacement member (3) is axially displaceable within the assembly (24), from a first closed position to a second open position;
it is configured so that the displacement of the axial displacement member (3) causes an irreversible change in the position of the axial displacement member (3) with respect to the assembly (24);
the axial displacement member (3) is fitted to the member (4) through axial retention means, namely of the clip type and the indentation type, presenting two positions:
   a first closed position, in which the face (51) of the alignment member (5) is aligned with the top surface (22) of the upper cover member (2)
   a second open position, in which the insertion member (6) is axially blocked in the lower cover member (4) and the face (51) of the alignment member (5) is recessed with respect to the top surface (22) of the upper cover member (2), thus resulting in misalignment of the face (51) relative to the surface (22).

In one embodiment, the upper cover member (2) and the lower cover member (4) are formed from a material selected from the group comprising plastic, wood, cork, composites and combinations thereof.

Elements (2) and (4) do not move relative to each other, functioning as a casing, being welded by ultrasound at the lower base and upper base of members (2) and (4), respectively. These two members (2) and (4) are connected in a rigid, inseparable and irreversible way.

In turn, the member (3) is an interior and central member, being the member whose position within the assembly (24) is modified axially when the capsule (1) of the invention is pulled or when an attempt is made to pull it with the purpose of removing it from the mouth or neck of a container. This modification of the position of the member (3) within the assembly (24) allows the detection of tampering or attempted tampering with the capsule.

The invention also relates to a container lid (8) comprising the capsule (1) and a stopper member (7), which is inserted and immobilized in the lower part of the axial displacement member (3), specifically, in its member (6) (FIGS. 1 and 2). The stopper member (7) is axially, longitudinally and rotationally immobilized with respect to the axial displacement member (3).

In another embodiment, the stopper member (7) is formed from a material selected from the group consisting of plastic, wood, cork, composites and combinations thereof.

The axial displacement member (3), when placing the capsule (1) in the mouth or neck of a container, is stationary due to the force that the mouth or neck of a container exerts on the stopper member (7). When the capsule (1) of the invention is pulled or when there is an attempt to pull it with the aim of removing it from the mouth or neck of a container, it is in the assembly (24) that the first movement occurs and it is through this movement that the axial displacement of the axial displacement member (3) relative to the assembly (24) occurs.

When the capsule (1) of the invention is placed in the mouth or neck of a container, when pulling it by its member (2), the assembly (24) rises relative to the member (3), leaving its upper faces horizontally misaligned. Thus, the member (3) is movable with respect to the assembly (24) and the latter is movable relative to the stopper member (7). However, the member (3) is immobile with respect to the stopper member (7).

Thus, when the capsule (1) for detecting container tampering is activated, in other words, when it is pulled or when there is an attempt to pull it with the aim of removing it, the assembly (24) rises relative to the member (3), in turn, the member (3) remains immobile until the displacement of the assembly (24) ends, blocks its position and gains sufficient force for the capsule (1) to be extracted from the container.

When the capsule (1) of the present invention is placed in the mouth or neck of a container, all its constituent members are positionally blocked in the closed position, specifically the axial displacement member (3), without any change in position or movement of the axial displacement member (3) within the assembly (24). In turn, when the capsule (1) of the invention is pulled or when there is an attempt to pull it with the aim of removing it, the force that the mouth or neck of the container exerts on the stopper member (7) will allow the assembly (24) to displace relative to the axial displacement member (3).

The stopper member (7) is a fundamental member for activating the capsule (1) of the invention, since the connection of the member (7) with the member (3), specifically, with its insertion member (6), allows movement of the assembly (24) relative to the member (3).

In one embodiment, the member (4) comprises axial retention means with the member (6) that will allow movement from the first initial position to the second final position, blocking the return from the second final position to the first initial position. These axial retention means allow the member (3) to be irreversibly connected, through its lower face, to the member (4), while at the same time allowing the member (3) to change its position axially. This connection between the member (4) and the member (3) occurs at the level of the lower face of the member (6), being a connection that allows the member (3) to vary from a first initial position to a second final position, not allowing the return to the first initial position. Said second final position is irreversible, and it is not possible for the constituent members of the capsule (1) of the invention to return to the first initial position, thus allowing the user to immediately perceive whether the capsule has been tampered and, accordingly, whether there has been at least one attempt to open the container.

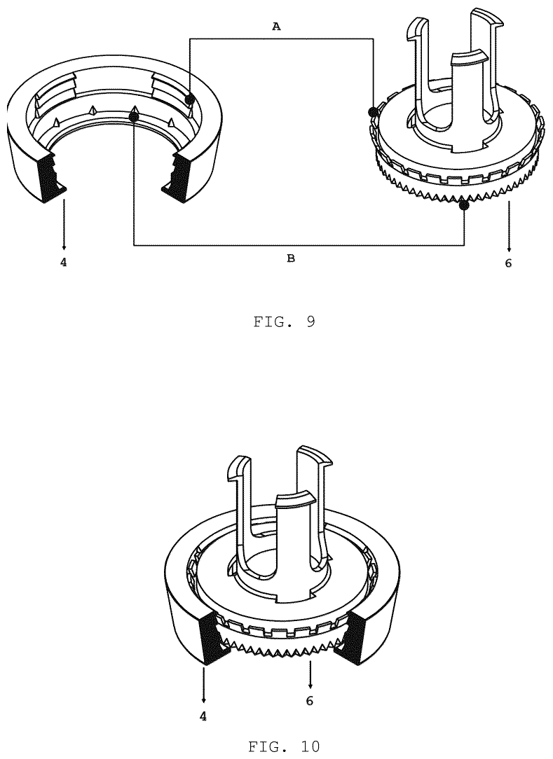

In a preferred embodiment, the axial displacement member (3) is fitted to the member (4) through retention means, namely of the clip type and of the indentation type, wherein the lower cover member (4) has fittings that interact with the clips of the insertion member (6), this interaction being what will allow the positioning of the insertion member (6) in the two possible position levels, closed position and open position, also allowing the axial position to be blocked when the insertion member (6) is positioned in the open position (FIG. 9). Furthermore, the lower cover member (4) has indentations that interact with the insertion member (6) when the latter is in the open position, blocking the axial rotation movement, in other words, the return to the closed position when in the open position (FIG. 9).

In turn, the alignment member (5), constituent of the axial displacement member (3), is inserted in the top through-opening (21) of the upper cover member (2), and said member (5) can displace freely with respect to the member (2). Thus, the fitting of members (5) and (2) is designed in such a way that there is no type of restriction or constraint on the axial movement of the member (3) in terms of interaction between member (2) and member (5). In the first closed position, the surface (22) of the member (2) and the face (51) of the alignment member (5) are horizontally aligned. In turn, in the second open position, the surface (22) of the member (2) and the face (51) of the alignment member (5) are horizontally misaligned.

When the assembly (24) is pulled by the user to remove the capsule (1) from the container, it displaces towards said second open position, dragging the axial displacement member (3) to the second position in this movement. In this position, the axial displacement member (3), having displaced axially within the assembly (24), assumes its resting state, in which it presents a misalignment of its upper face (face (51) of its member (5)) relative to the surface (22) of the member (2), contrary to the alignment of said faces (51) and surface (22) that occurs in the first closed position. This misalignment occurs due to the force that the mouth or neck of the container exerts on the stopper member (7), which will allow the assembly (24) to move relative to the member (3), causing said misalignment. In this second open position, wherein the member (3) is in its resting state and, as such, assuming a lower position (misalignment relative to the member (2)), with respect to the position it had in the first closed position, such axial variation of the member (3) associated with its connection with the member (4) through its axial retention means, causes a physical impediment to the return of the member (3) and, consequently, the assembly (24), to the first closed position, as illustrated in FIG. 4.

Preferably, in the assembly (24), the upper cover member (2) and the lower cover member (4) are irreversibly connected to prevent access from the outside to said cavity defined within it.

In turn, the upper cover member (2) is coupled to the lower cover member (4) through a permanent connection in order to safeguard access to the interior of the cavity, being that the assembly (24) formed by both said members displaces between the first closed position and the second open position as a single member. The permanent connection between the lower part of the upper cover member (2) and the upper part of the lower cover member (4) is carried out by any suitable method known to the person skilled in the art, for example, by gluing, welding, fitting, threading, or similar or combinations thereof.

The present invention also relates to a container lid (8) comprising the capsule (1) and a stopper member (7), intended for closing containers containing food or non-food products. In a preferred embodiment, container lid (8) is intended for closing containers containing a beverage, for example, wine, beer, spirits, water, soft drinks or the like, or containers containing a cosmetic product, for example, perfume, body hygiene products, beauty products or the like.

The present invention also relates to an operating process of the container tamper detection capsule (1).

The operating process of the capsule (1) of the invention comprises the step of displacing, by means of the assembly (24), the axial displacement member (3), from a first closed position to a second open, fixed and irreversible position, where:
in the first closed position, the face (51) of the alignment member (5) is aligned with a top surface (22) of the upper cover member (2);
in the second open position, the insertion member (6) is axially blocked in the lower cover member (4) and the face (51) of the alignment member (5) is recessed with respect to the top surface (22) of the upper cover member (2).

The irreversibility of the mechanism of the present capsule is achieved through the insertion member (6) which, when moving to the open position, is immobilized, both axially and longitudinally, in the lower cover member (4). This immobilization of the drive member (6) is achieved through axial retention means, namely, clip-type and indentation-type (FIG. 9).

The present invention also relates to a capsule production process (1) comprising the following steps:
fitting the insertion member (6) of the axial displacement member (3) to the lower cover member (4); and
attaching the upper cover member (2) and the lower cover member (4) by inserting the alignment member (5) into the top through-opening (21) of the upper cover member (2).

Furthermore, the invention also discloses a production process of the container lid (8) comprising the following steps:
fitting the insertion member (6) of the axial displacement member (3) to the lower cover member (4);
attaching the upper cover member (2) and the lower cover member (4), by inserting the alignment member (5) into the top through-opening (21) of the upper cover member (2); and
gluing a top of the stopper member (7) to a face (61) of the insertion member (6) through said bottom through-opening (41) of the lower cover member (4).

The container capsule (1) and lid (8) are for use in closing containers containing food or non-food products, in particular, containers containing a drink or containers containing a cosmetic product.

### EXAMPLE

With reference to FIG. 1 to X, the container tamper detection capsule (1) is made of three plastic parts: an upper cover member (2), an axial displacement member (3) and a lower cover member (4). In turn, the axial displacement member (3) comprises two plastic parts: the alignment member (5) and the insertion member (6).

Said members that make up the capsule (1) of the invention are produced separately by injection moulding.

Firstly, the members (5) and (6) are fitted together by the lower part of the alignment member (5) and the upper part of the insertion member (6), thus forming the axial displacement member (3). In turn, the member (3) is positioned inside the assembly (24) and the upper cover member (2) and the lower cover member (4) are welded together. This connection is irreversible, so that the axial displacement member (3) is inaccessible from the outside.

A cylindrical cork stopper is glued to the base of the body of the insertion member (6) and the opening of the lower cover member (4) has sufficient clearance to allow the stopper to be placed and allow this member (4) to move along of the stopper body. This combination of a cork stopper with the capsule (1) forms a lid (8) for containers.

The cap (8) thus formed is placed on a spirit bottle by inserting the cork stopper member (7) into the neck of the bottle.

To trigger the capsule detection mechanism (1), the user pulls the capsule (1) by the assembly (24) in order to remove the stopper from the bottle. With this movement, the assembly (24) moves upwards relative to the axial displacement member (3), passing from the first closed position to the second open position, causing a misalignment of the face (51) of the alignment member (5) relative to the top surface (22) of the upper cover member (2). The axial retention means of the members (4) and (6) allow movement from the first initial position to the second final position, but block the return from the second final position to the first initial position, thus making the blocking mechanism irreversible.

Tamper detection is carried out through said misalignment of the face (51) of the alignment member (5) relative to the top surface (22) of the upper cover member (2), which is visible to the user.

The description presented herein should be understood as exemplary and not limiting the scope of the present invention, which is defined in the attached claims.

It should be noted that although the present invention has been described with reference to its preferred embodiments, many modifications and alternatives can be made by a person skilled in the art without departing from the scope of the invention, which is defined by the claims.

1. A container tamper detection capsule (1), comprising:
an upper cover member comprising a top through-opening;
an axial displacement member comprising an alignment member and an insertion member; and
a lower cover member comprising a bottom through-opening;
wherein
the upper cover member is coupled to the lower cover member, forming an assembly that defines a cavity within; and
the axial displacement member is arranged in the cavity of the assembly, the said insertion member being fitted to the lower cover member and said alignment member inserted into the top through-opening of the upper cover member;
wherein, in operation,
the axial displacement member is axially displaceable relative to the assembly from a first closed position, in which a face of the alignment member is aligned with a top surface of the upper cover member, to a second open, fixed and irreversible position, in which the insertion member is axially blocked in the lower cover member and said face of the alignment member is recessed with respect to said top surface of the upper cover member.

2. The capsule according to claim 1, wherein the insertion member and the lower cover member comprise clip-type and indentation-type axial retention means.

3. The capsule according to claim 1, wherein the upper cover and lower cover members are made of a material selected from the group consisting of plastic, wood, cork, composites and combinations thereof.

4. A container lid comprising the capsule of claim 1 and a stopper member.

5. The container lid according to claim 4, wherein the stopper member is made of a material selected from the group consisting of plastic, wood, cork, aluminium, composites and combinations thereof.

6. A capsule production process according to claim 1 comprising the following steps:
fitting the insertion member of the axial displacement member to the lower cover member; and
attaching the upper cover member and the lower cover member, by inserting the alignment member into the top through-opening of the upper cover member.

7. A lid production process according to claim 4 comprising the following steps:
fitting the insertion member of the axial displacement member to the lower cover member;
attaching the upper cover member and the lower cover member, by inserting the alignment member into the top through-opening of the upper cover member; and
gluing a top of the stopper member to a face of the insertion member through said bottom through-opening of the lower cover member.

8. A method of closing a container comprising using the capsule according to claim 1 to close the container, wherein the container containing food or non-food products.

9. A method of closing a container comprising using the capsule according to claim 8 to close the container, wherein the container containing a beverage selected from the group consisting of wine, beer, spirits, water and soft drinks.

10. A method of closing a container comprising using the capsule according to claim 8 to close the container, wherein the container containing a cosmetic product.

11. A method of closing a container comprising using the lid according to claim 4 to close the container, wherein the container containing food or non-food products.

12. A method of closing a container comprising using the lid according to claim 11 to close the container, wherein the container containing a beverage selected from the group consisting of wine, beer, spirits, water and soft drinks.

13. A method of closing a container comprising using the lid according to claim 11 to close the container, wherein the container containing a cosmetic product.
